(19) United States
(12) Patent Application Publication
(10) Pub. No.: US 2016/0059155 A1
(43) Pub. Date: Mar. 3, 2016

(54) REVERSE FLOW CARAFE FILTER CARTRIDGE

(71) Applicant: KX Technologies LLC, West Haven, CT (US)

(72) Inventors: Andrew W. Lombardo, West Haven, CT (US); Stephen P. Huda, Shelton, CT (US); Frank A. Brigano, Northford, CT (US)

(21) Appl. No.: 14/841,005

(22) Filed: Aug. 31, 2015

Related U.S. Application Data
(60) Provisional application No. 62/043,861, filed on Aug. 29, 2014.

(51) Int. Cl. B01D 29/23; G06F 17/50; G06F 17/10; C02F 1/00

(52) U.S. Cl. CPC B01D 29/23; C02F 1/001; G06F 17/50; G06F 17/10; C02F 2201/006

(57) ABSTRACT

A carafe filter cartridge for reverse flow applications where the filter housing and filter media top end cap directs unfiltered fluid into the filter media annular cavity, through the filter media sidewalls. And the filter media bottom end cap prohibits egress, filter fluid from exiting through the filter media end or the annular cavity. Filtered fluid is instead directed out through apertures in the filter housing sidewall. The optimum ratio of annular cavity and/or top end cap orifice area to the respective perimeter is determined to remove the risk of detrimental fluid flow due to air bubble generation.

### BACKGROUND OF THE INVENTION

1. Field of the Invention

The present invention relates to a filter cartridge typically used in a gravity filtration system, where the filter media is enclosed in a filter housing where water flow is directed opposite the flow normally realized in the prior art. Specifically, the flow of the ingress water is directed towards and into the filter media central bore or annulus, while the flow of the egress, filtered water is directed radially outwards from the central bore through the filter media sidewalls. More specifically, the present invention provides a filter media and filter housing design that minimizes or eliminates the affect that accumulated air bubbles have on a filter media exposed to a reverse directional flow.

2. Description of Related Art

Disposable filter cartridges having pleated, granular, or carbon block filtration media, to name a few, are well known in the art. In this regard, the filter media is conventionally provided within a filter housing that directs fluid flow through the filter. For cylindrically shaped filters, which are dominant in the art for gravity-fed water filtration, especially for point-of-use configurations such as pitchers and countertop dispensers, the direction of fluid flow in the prior art lends itself to gravity-fed designs.

The unfiltered fluid propagates through circumferentially located and spaced apart flow channels formed in an outer flange of the filter housing top and/or side, and then into the lower portions of the interior chamber of the sump or body of the filter housing. The unfiltered fluid is essentially directed inwards, radially propagating inwards through the cylindrical filter media, such as a carbon block element or pleated filter media, and into the central bore (axial cavity) of the filter media cylinder. After travelling through the axial cavity of the filter media, the now-filtered fluid exits the filter media in gravity-fed applications at the lower or bottom end of the axial cavity through a filter media bottom end cap, and out the lower portion of the filter housing

The filter housing cover and body are designed with openings, apertures, and the like so as to allow fluid to flow normally longitudinally or axially downwards, and in a radial direction through the cylindrical walls of the filter media into the axial cavity. When the filtered fluid is discharged axially from the filter cartridge through a coaxially disposed discharge opening in one of the filter cartridge's end caps, it typically enters a reservoir for later dispensing.

In some industrial environments, it may be desirable to reverse the normal flow of the fluid through the filter cartridge so as to dislodge and remove accumulated particulates on the surface of a pleated filter media so that the filter cartridge substantially (if not completely) regains its initial filtration capabilities and/or so that fresh particulates may be pre-coated onto the filter media's surface. This is a back-flushing technique that is performed more often for certain types of filter applications, such as for pool system water filters, and filters that are difficult to access, such as underdrain filters in a nuclear power plant. In some industries (e.g., the power generation industry), filtration cartridges having filter media pre-coated with ion exchange particles are sometimes used. Thus, it would be desirable if exhausted ion exchange particles could be removed from the filter media via back-flushing so that fresh ion exchange particles could then be recoated onto the filter media's surface. This reverse flow backwashing of the filter media is of course under pressure to overcome the gravitational forces, and opposite the directional flow of filtration. Consequently, no “filtration” is performed during the reverse backwashing.

One reason for the prior art preferred directional flow of filtration (radially inwards through the filter media sidewalls to the annular cavity) is that gravity-fed systems induce air bubbles within the filter housing that can substantially reduce flow and/or airlock the filter cartridge from any filtration. If the directional flow of filtration was reversed (as is proposed in the present invention)—first through the annular cavity, then radially outwards through the filter media cylindrical sidewalls—air bubbles formed within the lower portion of the annular cavity would deter or block efficient filtrate flow. The present invention resolves this problem by forming a filter media with dimension limitations to reduce or eliminate blocking air bubbles in the annular cavity when ingress fluid is traversing into the annular cavity.

### SUMMARY OF THE INVENTION

Bearing in mind the problems and deficiencies of the prior art, it is therefore an object of the present invention to provide a reverse flow filter cartridge capable of efficient filtration when ingress fluid enters the annular cavity and is filtered as it traverses radially outwards through the filter media sidewalls.

The above and other objects, which will be apparent to those skilled in the art, are achieved in the present invention which is directed to a filter cartridge for gravity-fed reverse flow filtering applications comprising: a filter housing having a top, a bottom, and sidewalls having at least one aperture for fluid egress; a filter media insertable within the filter housing, the filter media shaped to have a central bore circumferentially surrounded by filter media sidewalls; a top end cap having an aperture to allow ingress fluid to the central bore, and sealed to prohibit fluid ingress to the filter media sidewalls except through the central bore; a bottom end cap configured to prohibit egress fluid from leaving the filter media; wherein ingress fluid enters the central bore and is directed through the filter media sidewalls, and exits through the at least one aperture of the filter housing sidewall.

The central bore or the top end cap aperture is defined by an area such that the maximum flow rate into the central bore, Fₘₐₓ, is greater than the flow rate through the filter media, and is determined by head height pressure and central bore cross-sectional area, by the expression:

Fₘₐₓ=(\sqrt{Hᵣ*2*g})*(Aₒ)*6*10⁷

where,
Hᵣ=head height (mm);
g=9.8 m/s²; and
Aₒ=cross-sectional area of top cap opening (mm²).

The reduction in air bubble production in the central bore of the filter media of the reverse flow filtering applications may be optimized by maintaining a ratio of central bore cross-sectional area to central bore perimeter at a value equal to or greater than approximately 2.25.

The central bore has a cylindrical cross-section, a square or rectangular cross-section, an oval cross-section, or an obround cross-section, such that the ratio remains equal to or greater than approximately 2.25.

The top end cap aperture exhibits greater than 2950 ml/min flow at a maximum head pressure or greater than 4664 ml/min at maximum head pressure.

In a second aspect, the present invention is directed to a filter cartridge for reverse flow filtering applications comprising: a filter housing having at least one aperture for fluid ingress and at least one aperture for fluid egress; a filter media insertable within the filter housing, the filter media shaped to have a central bore in fluid communication with the at least one aperture for fluid ingress, the central bore circumferentially surrounded by filter media sidewalls; a top end cap having an aperture to allow fluid ingress to the central bore, and sealed to prohibit fluid ingress to the filter media sidewalls except through the central bore; a bottom end cap configured to prohibit fluid from leaving the filter media; wherein ingress fluid enters the central bore and is directed through the filter media sidewalls, and exits through the at least one aperture of the filter housing sidewalls; and wherein the central bore or the top end cap aperture is defined by an area such that the maximum flow rate into the central bore, Fₘₐₓ, is greater than the flow rate through the filter media, and is determined by head height pressure and central bore cross-sectional area, by the expression:

Fₘₐₓ=(\sqrt{Hᵣ*2*g})*(Aₒ)*6*10⁷

where,
Hᵣ=head height (mm);
g−9.8 m/s²; and
Aₒ=cross-sectional area of top cap opening (mm²)
   and wherein the reduction in air bubble production in the central bore or the top end cap aperture is optimized by maintaining a ratio of cross-sectional area to perimeter of the central bore or the top end cap aperture at a value equal to or greater than approximately 2.25.

In a third aspect, the present invention is directed to a method for eliminating airlock in a reverse-flow filter cartridge assembly, where the filter cartridge assembly includes a filter housing, a filter media inside the filter housing having a top end cap, the filter media having a central bore for fluid received from an aperture on the top end cap, said method comprising: defining a top end cap aperture area, Aₒ, such that the maximum flow rate into said central bore, Fₘₐₓ, is greater than the flow rate through said filter media, and is determined by head height pressure and top end cap aperture cross-sectional area, by the expression:

Fₘₐₓ=(\sqrt{Hᵣ*2*g})*(Aₒ)*6*10⁷

where,
Hᵣ =head height (mm);
g=9.8 m/s²; and
Aₒ=cross-sectional area of op cap opening (mm²)
   calculating a ratio of the area to a perimeter of the top end cap aperture; and adjusting said area or said perimeter or both such that said ratio is greater than 2.25.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a perspective cross-sectional view of a gravity-fed carafe filter design with a reverse-flow filter cartridge of the present invention;

FIG. 2 depicts a cross-sectional view of the carafe of FIG. 1, with arrows depicting the direction of the reverse fluid flow;

FIG. 3 depicts a cross-sectional view of a reverse flow carafe filter cartridge having an air pocket formed therein;

FIGS. 4 and 5 depict the values for flow, Fₘₐₓ, as a function of various predetermined head heights and areas;

FIG. 6 depicts tabular values of flow based on different cross-sectional areas for the top cap aperture and annular cavity having a circular cross-section;

FIG. 7 depicts tabular values of flow based on different cross-sectional areas for the top cap aperture and annular cavity having a square cross-section;

FIG. 8 depicts tabular values of flow based on different cross-sectional areas for the top cap aperture and annular cavity having an oval cross-section;

FIG. 9 depicts a top view of an upper end cap having a star-shaped aperture with an air bubble formed by fluid flow into aperture and resulting back pressure from within the filter housing; and

FIG. 10 is a lower perspective view of the end cap of FIG. 9 with the filter media removed.

### DESCRIPTION OF THE PREFERRED EMBODIMENTS

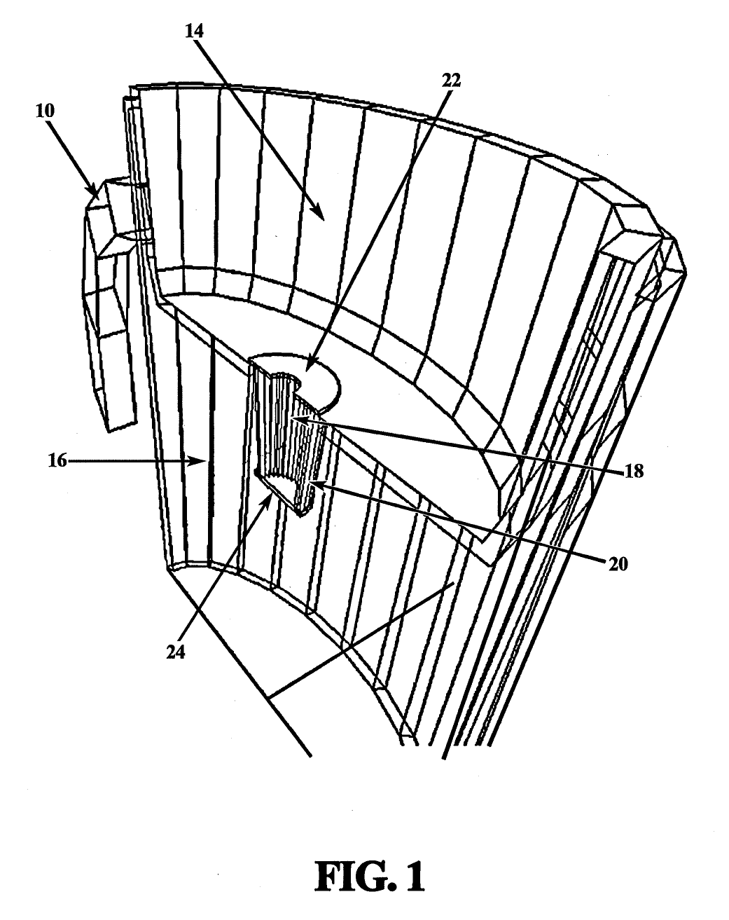

In describing the preferred embodiment of the present invention, reference will be made herein to FIGS. 1-10 of the drawings in which like numerals refer to like features of the invention.

FIG. 1 depicts a perspective cross-sectional view of a gravity-fed carafe filter design 10 with a reverse-flow filter cartridge 12 of the present invention. Carafe 10 includes atop reservoir 14 for receiving unfiltered water, and a bottom reservoir 16 for receiving filtered water that passes through filter cartridge 12. Filter cartridge 12, as depicted, is preferably cylindrical in shape, having an annular cavity or central bore 18 and housing sidewall 28, the housing sidewalls having a thickness in the radially direction. Filter cartridge 12 also includes a top end cap 22 and bottom end cap 24, both adhered to the filter media.

The particular filter media which is employed in the practice of this invention is not critical. Thus, any conventional activated carbon block or pleated non-woven fibrous filter media may be employed having the desired porosity.

As water needing treatment passes through the filter cartridge of a standalone point of use water purification device, such as a carafe filter cartridge, it will contact the filter media, and the quantity of filter media contacted by the water and the water flow rate determine the absorption efficiency.

As the water flows through the filter cartridge, it takes the path of least resistance and makes its own channels through the filter media. For a reverse flow filter cartridge, the water enters the annular cavity or central bore of the filter media and exits radially outwards through the filter media sidewalls.

It is understood that other shaped configurations are easily adaptable for the filter media design of the present invention, such as oval, square, triangular, obround, or the like. Certain shapes may be more inclined to accommodate particular types of filter media and thus the cross-sectional shape of the filter assembly may be something other than circular for receiving a cylindrical housing; rather, for instance, it may be oval, obround, or rectangular, to name a few, provided the geometric configuration allows for a central bore for receiving unfiltered fluid and allows for fluid to exit via the sidewalls. In such designs, the bottom end cap is designed not to allow fluid flow so that fluid has no alternative but to exit the filter media via the filter media side walls.

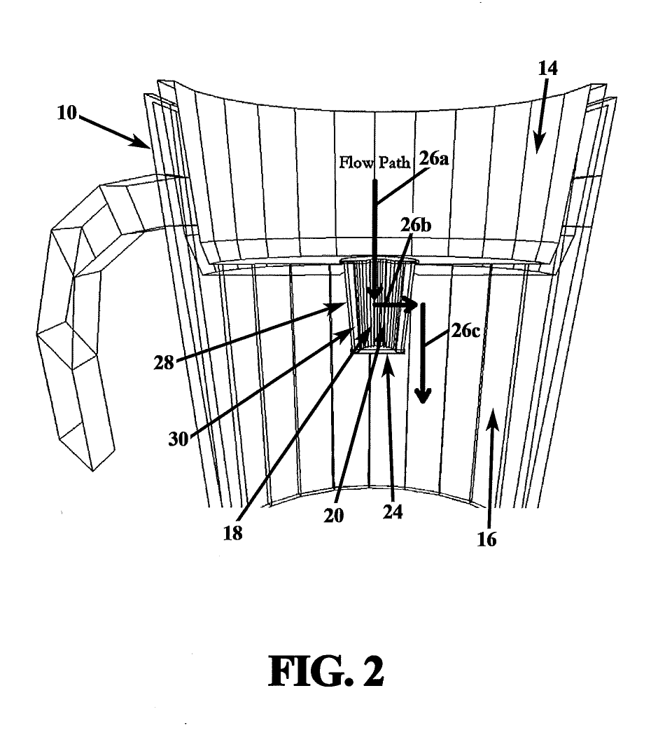

FIG. 2 depicts a cross-sectional view of carafe 10 of FIG. 1, with arrows 26a,b,c depicting the direction of the reverse fluid flow. Fluid flow generated by gravitational forces is directed from top reservoir 14 by an aperture in top end cap 22 in the direction of arrow 26a into annular cavity 18. Top end cap 22 is typically adhered to the top surface of the filter media and provides an opening or aperture coaxial with filter media inner annular cavity 18 to enable fluid to flow into annular cavity 18.

Fluid flow will generally traverse longitudinally downwards until it reaches bottom end cap 24, which is circumferentially sealed to the filter media lower or bottom end. A back pressure is generated by the fluid, unable to exit the filter media from the bottom. Fluid is then directed radially outwards 26b through filter media sidewalls 20. The filter bottom end cap 24 prohibits fluid from exiting the filter media in any direction except radially outwards in the direction of arrow 26b. That is, contrary to prior art designs, in the preferred embodiment, the bottom end cap does not include a discharge opening coaxially aligned with the interior central passageway or annular cavity 18 of the internal core element of the filter media. Fluid is directed through the filter media sidewalls to circumferential channel 30 located between the filter housing sidewall 28 and filter media outer sidewall surface 20, and then exits apertures located on filter housing sidewall 28. Filter cartridge bottom end cap 24 is sealed to the filter media at least about the portion that connects to the bottom surface of the filter media. In this manner, fluid must exit through filter media sidewalls 20, and then through apertures located on the filter housing sidewall 28 in order to flow into bottom reservoir 16 as depicted by directional flow 26c.

As discussed previously, a significant detriment to establishing filter flow in this “reverse” direction (direction opposite the normal filtration direction of the prior art) is the establishment of an air bubble or pocket 32 in the annular cavity 18 of the filter media.

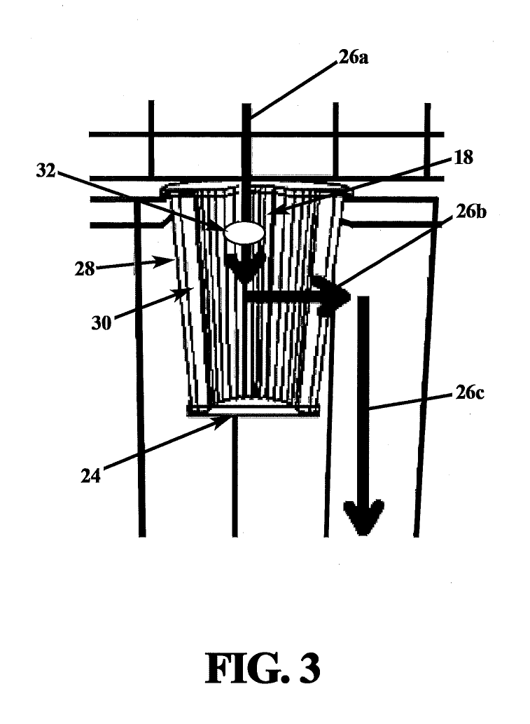

FIG. 3 depicts a cross-sectional view of a reverse flow carafe filter cartridge having an air pocket 32 formed therein. In order to ensure proper filtration, flow of water into annular cavity 18 must be at least as fast as the flow out the filter media, otherwise filtration will become exceedingly slow due to the air pocket (air bubble) formation. Depending upon the size of air bubble or pocket 32, flow into the filter media annular cavity 18 may be significantly slowed, and thus adversely affect the filtration rate.

It has been determined that designing the filter cartridge to particular geometrical considerations will enhance the flow rate of the fluid and substantially decrease the formation of air bubbles or pockets capable of affecting the flow rate. This determination facilitates reverse-flow by analytically accommodating the flow rate.

For a particular head pressure or head height, Hᵣ, and cross-sectional area, Aₒ, of the top end cap opening that allows for fluid ingress, the top cap will allow for maximum fluid flow, Fₘₐₓ, as represented by the following equation:

Fₘₐₓ=(\sqrt{Hᵣ*2*g})*(Aₒ)*6*10⁷

where,
Hr=head height (mm);
g=9.8 m/s²;
Aₒ=cross-sectional area of top cap opening (mm²).

It is desirable to have Fₘₐₓ greater than the flow rate of filter media egress, such that head pressure can build to drive the fluid through the filter.

This equation represents the relationship between the maximum flow rate, Fₘₐₓ on milliliters per minute (ml/min), and the head height, Hᵣ (mm), and cross-sectional area of the top end cap opening, Aₒ (mm²), for a reverse flow gravity-fed carafe filter cartridge system.

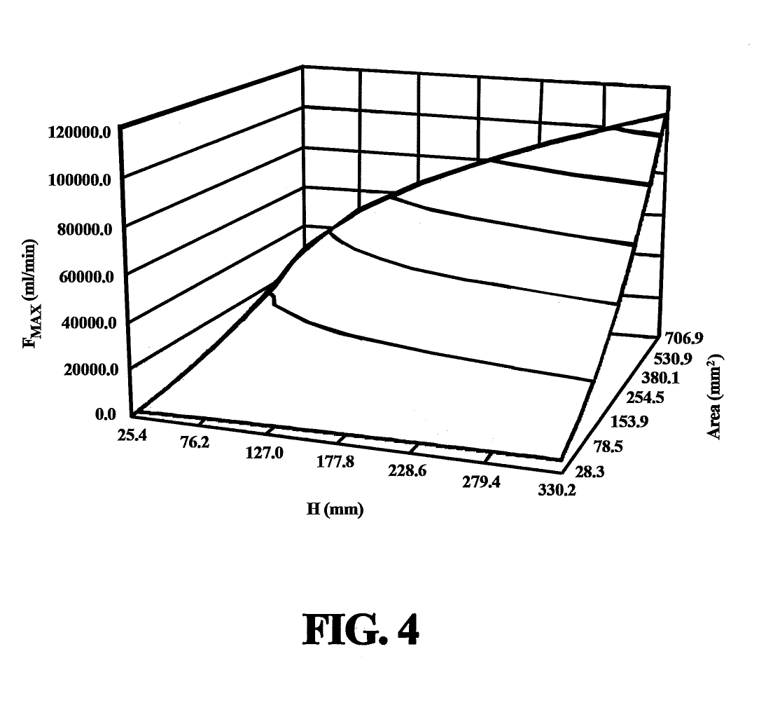

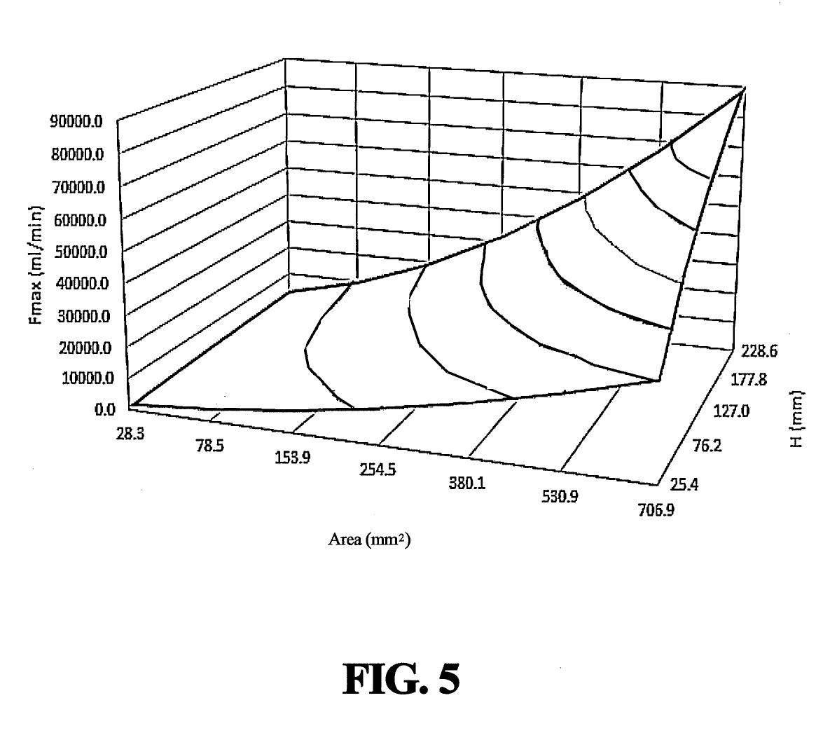

FIGS. 4 and 5 depict the values for flow, Fₘₐₓ, as a function of various predetermined head heights and areas. Area was varied from 28 mm² to 700 mm², which are equivalent to hole diameters from 6 mm to 30 mm. Head heights were varied from 25 mm to 330 mm (the 330 mm equates to approximately 13 inches in head height).

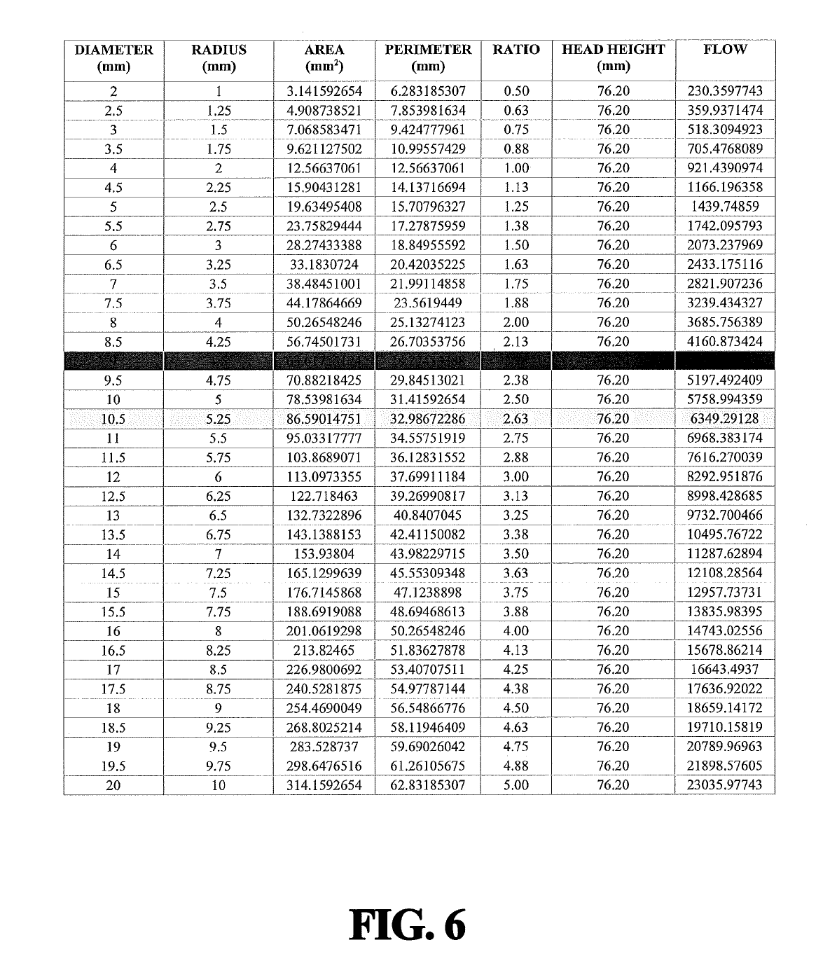

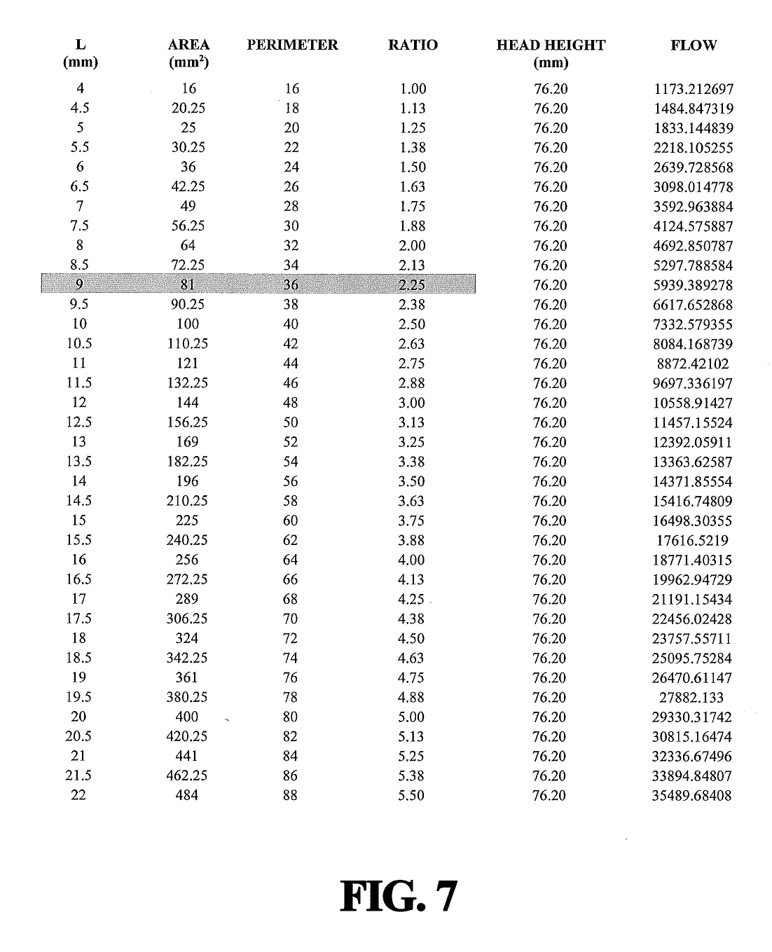

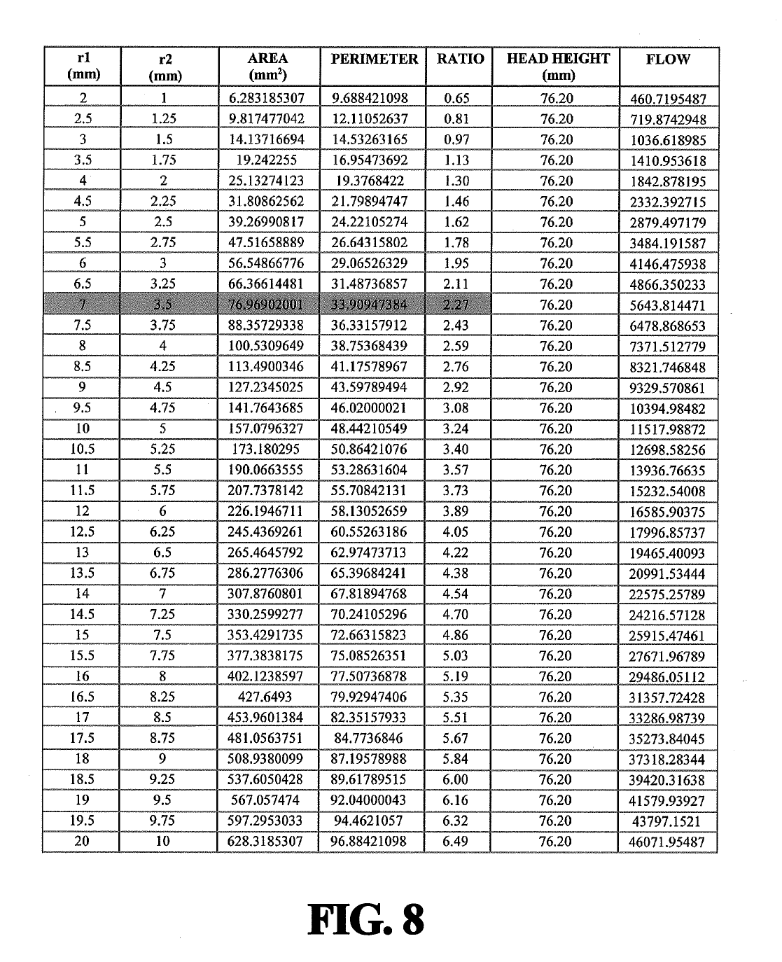

FIGS. 6-8 depict tabular values of flow based on different cross-sectional areas for the top cap aperture and annular cavity. FIG. 6 depicts values for a circular cross-section; FIG. 7 depicts values for a square cross-section; and FIG. 8 depicts values for an oval cross-section.

It should be noted that the cross-sectional area of the end cap aperture is a governing factor, and not the particular shape of the aperture. More particularly, as calculated, the ratio of the area of the cavity to the perimeter of the cavity, independent of the cavity shape, e.g., circular, square, oval, etc., determines the suitable criteria for addressing adverse air bubble formation.

As indicated, it has been determined that an optimum ratio of the aperture area to perimeter should be greater than 2.25 to overcome the surface tension presented by air bubble formation, and remove detrimental effects from air bubbles in a reverse carafe filter cartridge system, especially where the top cap orifice exhibited greater than 2950 ml/min flow at the maximum head pressure, or alternatively, where the top cap orifice exhibits greater than 4664 ml/min flow at maximum head pressure.

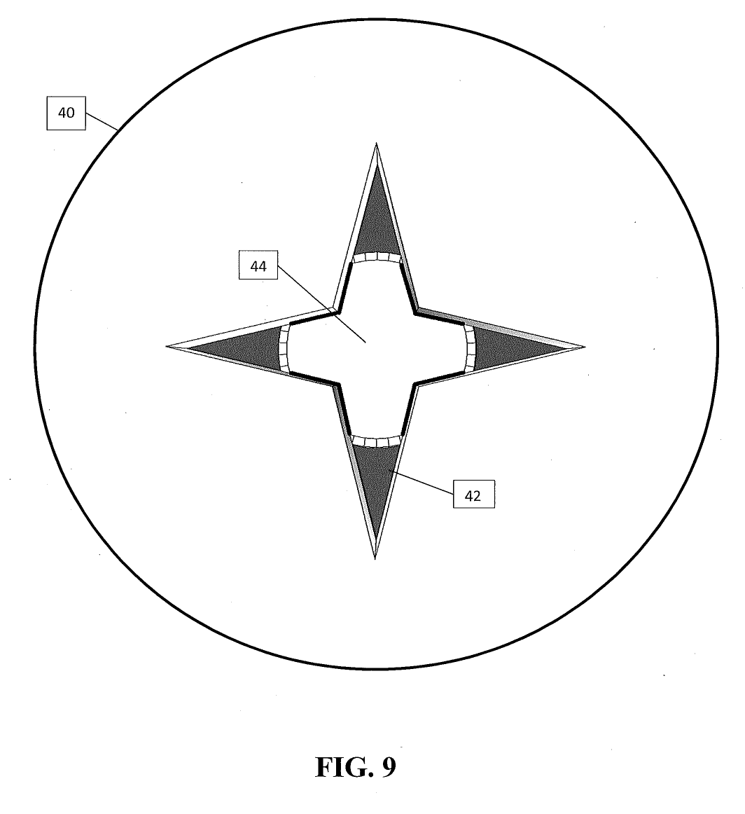

FIG. 9 depicts a top view of an upper end cap 40 having a star-shaped aperture 42 with an air bubble 44 formed by fluid flow into aperture 42 and resulting back pressure from within the filter housing. In this embodiment, it is evident that an air bubble may be trapped within the filter housing, yet allow a certain amount of fluid to flow into the filter housing and into the filter media. The rate of flow is predicated on the optimum ratio of area to perimeter of the aperture, and not dependent solely on the aperture shape. Preferably this ratio should be greater than 2.25 to overcome the surface tension presented by air bubble formation.

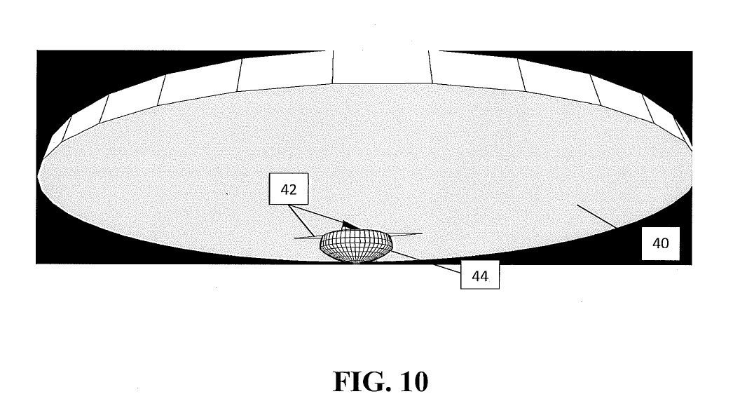

FIG. 10 is a lower perspective view of the end cap 40 of FIG. 9 with the filter media removed. The filter media would be secured to the underside of end cap 40, and have an axial center to receive fluid flow and direct air bubble formation.

The present invention further provides for a method of designing a reverse-flow filter cartridge assembly, where the filter cartridge assembly includes a filter housing, a filter media inside the filter housing having an end cap at each end, the filter media having a central bore for fluid ingress received from an aperture on the top end cap, and ensuring that the ratio of the area of either the top end cap aperture or the central bore, to their respective perimeter, is greater than 2.25 to maximize the flow rate based on the above-identified expression.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A filter cartridge for gravity-fed reverse flow filtering applications comprising:
a filter housing having a top, a bottom, and sidewalls having at least one aperture for fluid egress;
a filter media insertable within said filter housing, said filter media shaped to have a central bore circumferentially surrounded by filter media sidewalls;
a top end cap having an aperture to allow ingress fluid to said central bore, and sealed to prohibit fluid ingress to said filter media sidewalls except through said central bore;
a bottom end cap configured to prohibit egress fluid from leaving said filter media;
wherein ingress fluid enters said central bore and is directed through said filter media sidewalls, and exits through said at least one aperture of said filter housing sidewall.

2. The filter cartridge of claim 1 wherein said central bore or said top end cap aperture is defined by an area such that the maximum flow rate into said central bore, Fₘₐₓ, is greater than the flow rate through said filter media, and is determined by head height pressure and central bore cross-sectional area, by the expression:
Fₘₐₓ=(\sqrt{Hᵣ*2*g})*(Aₒ)*6*10⁷
where,
Hᵣ=head height (mm);
g=9.8 m/s²; and
Aₒ=cross-sectional area of top cap opening (mm²).

3. The filter cartridge of claim 1, wherein the reduction in air bubble production in said central bore of said filter media of said reverse flow filtering applications is optimized by maintaining a ratio of central bore cross-sectional area to central bore perimeter at a value equal to or greater than approximately 2.25.

4. The filter cartridge of claim 2, wherein said central bore has a cylindrical cross-section, a square or rectangular cross-section, an oval cross-section, or an obround cross-section, such that said ratio remains equal to or greater than approximately 2.25.

5. The filter cartridge of claim 3, wherein the top end cap aperture exhibits greater than 2950 ml/min flow at a maximum head pressure.

6. The filter cartridge of claim 3, wherein the top end cap aperture exhibits greater than 4664 ml/min flow at a maximum head pressure.

7. A filter cartridge for reverse flow filtering applications comprising:
a filter housing having at least one aperture for fluid ingress and at least one aperture for fluid egress;
a filter media insertable within said filter housing, said filter media shaped to have a central bore in fluid communication with said at least one aperture for fluid ingress, said central bore circumferentially surrounded by filter media sidewalls;
a top end cap having an aperture to allow fluid ingress to said central bore, and sealed to prohibit fluid ingress to said filter media sidewalls except through said central bore;
a bottom end cap configured to prohibit fluid from leaving said filter media;
wherein ingress fluid enters said central bore and is directed through said filter media sidewalls, and exits through said at least one aperture of said filter housing sidewalls; and
wherein said central bore or said top end cap aperture is defined by an area such that the maximum flow rate into said central bore, Fₘₐₓ, is greater than the flow rate through said filter media, and is determined by head height pressure and central bore cross-sectional area, by the expression:
Fₘₐₓ=(\sqrt{Hᵣ*2*g})*(Aₒ)*6*10⁷
where,
Hᵣ=head height (mm);
g=9.8 m/s²; and
Aₒ=cross-sectional area of top cap opening (mm²)
and wherein the reduction in air bubble production in said central bore or said top end cap aperture is optimized by maintaining a ratio of cross-sectional area to perimeter of said central bore or said top end cap aperture at a value equal to or greater than approximately 2.25.

8. The filter cartridge of claim 7, wherein the top end cap aperture exhibits greater than 2950 ml/min flow at a maximum head pressure.

9. The filter cartridge of claim 7, wherein the top end cap aperture exhibits greater than 4664 ml/min flow at a maximum head pressure.

10. A method for eliminating airlock in a reverse-flow filter cartridge assembly, where the filter cartridge assembly includes a filter housing, a filter media inside the filter housing having a top end cap, the filter media having a central bore for fluid received from an aperture on the top end cap, said method comprising:
defining a top end cap aperture area, Aₒ, such that the maximum flow rate into said central bore, Fₘₐₓ, is greater than the flow rate through said filter media, and is determined by head height pressure and top end cap aperture cross-sectional area, by the expression:
Fₘₐₓ=(\sqrt{Hᵣ*2*g})*(Aₒ)*6*10⁷
where,
Hᵣ=head height (mm),
g=9.8 m/s²; and
Aₒ=cross-sectional area of top cap opening (mm²)
calculating a ratio of the area to a perimeter of the top end cap aperture; and
adjusting said area or said perimeter or both such that said ratio is greater than 2.25.

11. A method for eliminating airlock in a reverse-flow filter cartridge assembly, where the filter cartridge assembly includes a filter housing, a filter media inside the filter housing having a top end cap, the filter media having a central bore for fluid received from an aperture on the top end cap, said method comprising:
defining an area, Aₒ, of said central bore such that the maximum flow rate into said central bore, Fₘₐₓ, is greater than the flow rate through said filter media, and is determined by head height pressure and central bore cross-sectional area, by the expression:
Fₘₐₓ=(\sqrt{Hᵣ*2*g})*(Aₒ)*6*10⁷
where,
Hᵣ=head height (mm);
g=9.8 m/s²; and
Aₒ=cross-sectional area of top cap opening (mm²)
calculating a ratio of the area to a perimeter of the central bore; and
adjusting said area or said perimeter or both such that said ratio is greater than 2.25.
